(19) United States
(12) Patent Application Publication
(10) Pub. No.: US 2011/0014009 A1
(43) Pub. Date: Jan. 20, 2011

(54) IMPACT DRIVEN FASTENER

(75) Inventors: Matthew Rothgery, Prescott Valley, AZ (US); Ramiro Valle Alvarez, Prescott Valley, AZ (US)

Correspondence Address: HOME TECH INVESTMENTS, L.L.C., 4680 North Wagon Way, Prescott Valley, AZ, 86314, US

(73) Assignee: HOME TECH INVESTMENTS, L.L.C., Prescott Valley, AZ (US)

(21) Appl. No.: 12/505,343

(22) Filed: Jul. 17, 2009

(51) Int. Cl. F16B 15/06

(52) U.S. Cl. 411/453

(57) ABSTRACT

An impact driven fastener having plural shank elements formed into a unitary shank structure of helical geometry.

### BACKGROUND OF THE INVENTION

The present invention pertains to the endeavor to create an improved impact driven fastener for use in ground anchoring, joining wooden structural members, affixing finishing materials or any such application.

The fastening capabilities of a standard nail, stake or tack are determined by the material used, its cross sectional area and the measure of the periphery making frictional contact with the substrate. Deformities are often introduced into the geometry of these fasteners for improved contact with the substrate or fastened member, e.g. a widened head, thickened rings, barbs, axial striations, helical striations or threads. A widened head prevents the fastener from pulling through the fastened member and may ease installation. In the case of such deformities as rings and barbs, better fastening capability depends on the resilience of the substrate material to return to its original shape otherwise the fastener may simply retreat from the very hole into which it was driven. Axial striations increase the surface area in frictional contact with the substrate, which increases the fastening capabilities. A helical deformation, too, increases the surface area in frictional contact with the substrate but also prevents the fastener from simply retreating from the hole into which it was driven.

It should be emphasized that the present invention relates to impact driven fasteners, those installed by means of axial force, i.e. repeated blows of a hammer or a high-impact nailing tool. Helical threads that are commonly seen on screw fasteners are of such a small pitch that rotational force is required for installing these screws contrasting with a helical shape of a large pitch which simply tends to rotate as it is driven in the direction of the axis. Frictional contact with the fastened members prevents the twisting motion required for a helical shape to retreat from the hole into which it was driven. Mechanical interference at the helical surface between the fastener and fastened members prevents the fastened members from separating.

Various methods are used in the manufacture of impact driven fasteners to introduce the deformities described. These manufacturing methods and tooling requirements are costly.

Examining the functionality and cost of available fasteners gives cause to the endeavor of the present invention. One objective of the endeavor is to optimize the geometry of an impact driven fastener for use in more varied applications, neglecting the properties of the fastened materials. Another objective of the endeavor is to more closely match the fastening strength of a fastener to the strength of the material used in the fastener thereby improving cost efficiency. Still another objective is to minimize the cost of manufacturing an impact driven fastener.

### BRIEF SUMMARY OF THE INVENTION

The objectives of the present invention are met by manufacturing an impact driven fastener having plural uniform shank elements formed into a unitary shank structure of a helical geometry. More plainly described as a fastener comprising two or more uniform wires or rod shapes twisted together. Claim 1 describes the basic shape implemented as the shank of an impact driven fastener regardless of various deformities and coatings applied to the shank. Claims 2 & 3 describe bonding together the elements comprising the fastener in claim 1.

### BRIEF DESCRIPTION OF THE DRAWINGS

FIG. 1 is a perspective view of the fastener as described in claim 1.

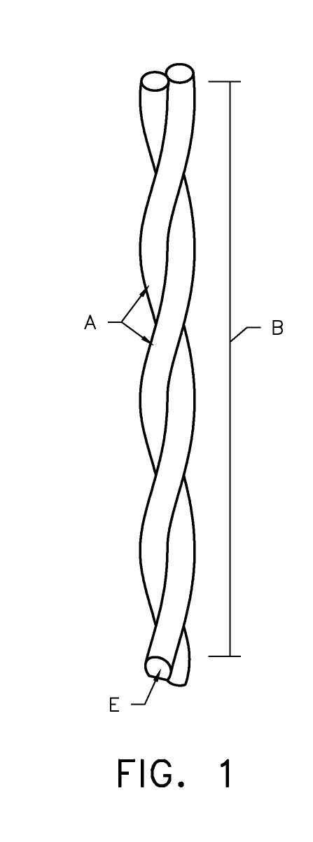

FIG. 2 shows alternative implementations still complying with claim 1.

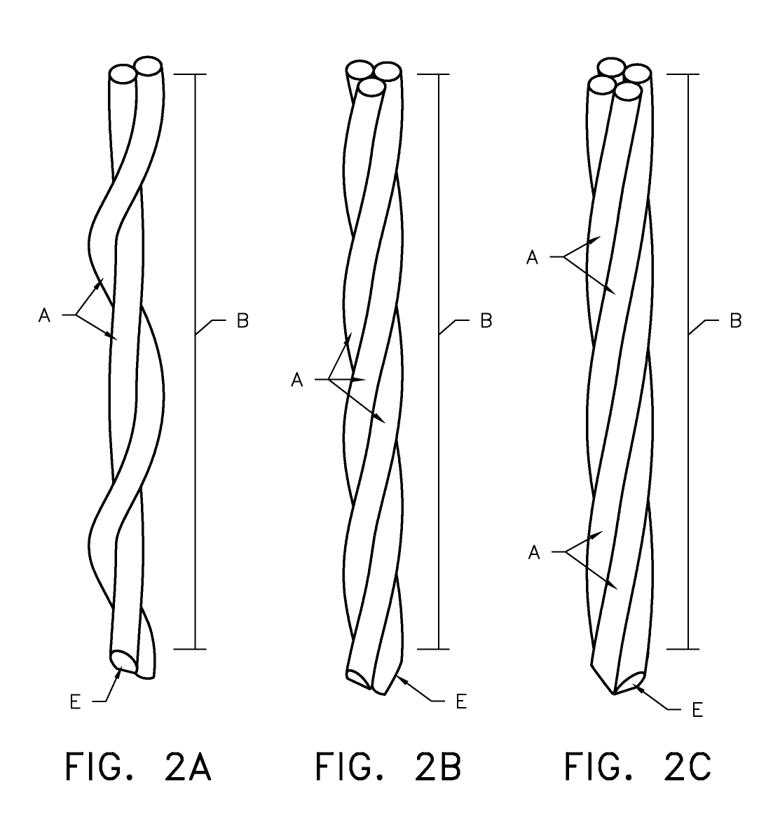

FIG. 3 shows the various deformations of the fastener while still embodying the description of claim 1.

FIG. 4 is a cross-sectional view of the fastener installed into fastened member and substrate.

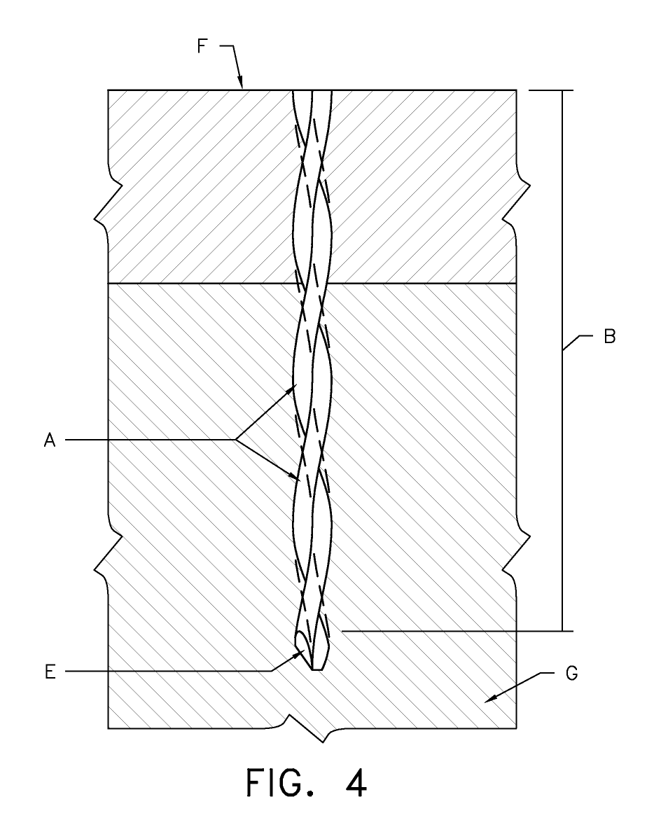

Descriptions for Letter References in all Drawings are Consistent:

(A) Designates a shank element

(B) Designates the unitary shank structure

(C) Designates a location of shank element mending

(D) Designates a head deformation

(E) Designates a pointed tip deformation

(F) Designates the fastened member

(G) Designates the substrate (also a fastened member)

### DETAILED DESCRIPTION OF THE INVENTION

No claim is made regarding the process of manufacturing the present invention or the materials used. The elements that distinguish the present invention from prior art are what is claimed regardless of their material composition or fabrication method. Use of the word “twisted” in this document is intended to describe a shape, not a process. Referring to the present invention as depicted in the drawings:

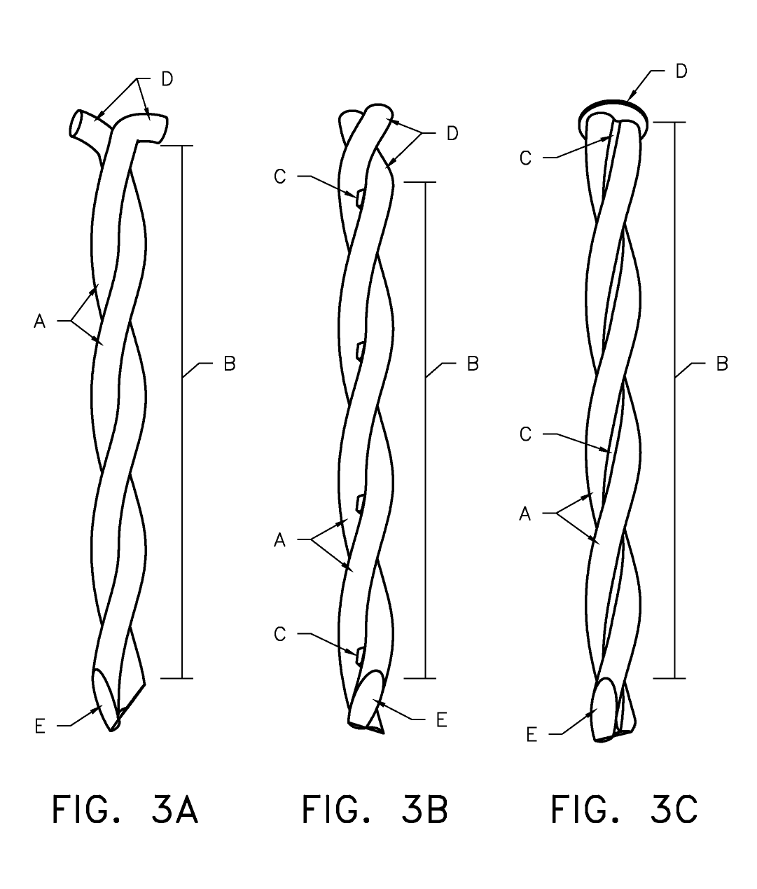

Shank elements (A) are tightly twisted around each other to form a unitary shank structure (B). Greater fastening strength is obtained due to the larger surface area of the unitary shank structure (B) in frictional contact with the fastened members (F)(G). This, combined with the fastening strength due to mechanical interference at the helical surface between the shank structure (B) and fastened members (F)(G), more closely matches the strength of the material used. That is to say, force applied to breaking the bond of the fastened members (F)(G) is more equally likely to cause failure of the shank structure itself (B) than to cause the fastener to separate from the fastened members. More efficiency is gained comparing the amount of material used to the fastening strength provided, thereby lowering the cost.

Wherever it is convenient, bonding, or welding (C) together the shank elements (A) may stabilize the shank structure (B) if excessive driving force is required. If the weld is not uniform and continuous, then there is a small loss of frictional contact of the shank (B) with the fastened members (F)(G). Depending on the size of the deformation caused by the weld and the resilience of the fastened members, this loss may be negligible.

Where the depth of the fastened member (F) does not allow a substantial portion of the helical shape (B) to be embedded, a head deformation (D) may be introduced to prevent the fastener (B) from pulling through the fastened member. This deformation (D) may be introduced by bending the shank elements (A) as shown in FIG. 3A or by decreasing the pitch of the helical shape as shown in FIG. 3B or by bonding the shank to a head element as shown in FIG. 3C.

The leading end of the impact driven fastener may be pointed or tapered (E) to ease the driving force. Consideration is given to the geometry of the point (E) so that the driving force also serves to more tightly bind the shank elements (A) together while the fastener is being driven.

Thermoplastic coatings or galvanization, which are commonly applied to fasteners, may benefit the present invention. Such treatments may further serve to bond shank elements (A) together.

1. An impact driven fastener having plural shank elements formed into a unitary shank structure of helical geometry; said shank elements having a uniform cross-sectional shape along their individual lengths; and all of said shank elements united in a helical arrangement to form said unitary shank structure.

2. An impact driven fastener complying with claim 1 with said shank elements further bonded together by periodic welding along the length of said shank elements; said welding by any convenient means.

3. An impact driven fastener complying with claim 1 with said shank elements further bonded together by continuous welding along the length of said shank elements; said welding by any convenient means.
